(19) United States
(12) Patent Application Publication
(10) Pub. No.: US 2022/0032929 A1
(43) Pub. Date: Feb. 3, 2022

(54) FAULT-TOLERANT TRACKING CONTROL METHOD FOR FOUR-WHEEL DISTRIBUTED ELECTRIC DRIVE AUTONOMOUS VEHICLE

(71) Applicant: Beijing Institute of Technology, Beijing (CN)

(72) Inventors: Weida WANG, Beijing (CN); Chao YANG, Beijing (CN); Yuhang ZHANG, Beijing (CN); Wei WANG, Beijing (CN); Zheng MA, Beijing (CN); Changle XIANG, Beijing (CN)

(21) Appl. No.: 17/320,022

(22) Filed: May 13, 2021

(30) Foreign Application Priority Data
Jul. 31, 2020 (CN) 202010764654.7

(51) Int. Cl. B60W 50/02; B60W 60/00; B60W 50/038; B60W 30/06; B60W 10/18; B60W 10/08; B60W 10/119

(52) U.S. Cl. CPC B60W 50/0205; B60W 60/0015; B60W 50/038; B60W 30/06; B60W 10/18; B60W 2520/28; B60W 10/119; B60W 2510/083; B60W 2520/10; B60W 2520/14; B60W 10/08

(57) ABSTRACT

The present disclosure provides a fault-tolerant tracking control method of a four-wheel distributed electric drive autonomous vehicle. The method depends on a typical four-wheel distributed electric drive vehicle structure, comprising: first, realizing real-time acquisition of an output torque and a fault coefficient of a hub motor through each vehicle-mounted sensor and each parameter observer; then determining whether the vehicle power system enters a fault state, and if the hub motor is in the fault state, entering a set fault-tolerant tracking link; and judging the fault mode of the current vehicle, using different control logics for different fault modes, and finally realizing fault-tolerant control or emergency risk avoiding of the vehicle. According to the present disclosure, aiming at different fault conditions of a power system of the distributed electric drive autonomous vehicle, different coping modes and control strategies are used for guaranteeing the stability and safety of the vehicle as much as possible, and the safety of passengers and goods is guaranteed.

### CROSS REFERENCE TO RELATED APPLICATION(S)

This patent application claims the benefit and priority of Chinese Patent Application No. 202010764654.7, filed on Jul. 31, 2020, the disclosure of which is incorporated by reference herein in its entirety as part of the present application.

### TECHNICAL FIELD

The present disclosure relates to the technical field of vehicles, in particular to a fault-tolerant tracking control method of a four-wheel distributed electric drive autonomous vehicle.

### BACKGROUND ART

A four-wheel distributed electric drive auto-driving vehicle has one or more hub motor faults when driving along the preset trajectory, and it has no torque output or can only provide part of the required driving torque, which will result in the problem that it is difficult for the vehicle to track the preset trajectory under the original control law. It even has the risk of vehicle instability, which affects the safety of the vehicle.

At present, the fault processing method for a four-wheel distributed electric drive autonomous vehicle is relatively simple. Generally, the fault information is diagnosed. After the fault information level is obtained, the fault is processed according to the fault information level. When the fault level is low, the fault is generally not processed actively, but when the fault level exceeds a certain threshold, the fault is generally processed by controlling the vehicle to return to the vehicle maintenance point or by emergency braking. However, for a four-wheel distributed electric drive autonomous vehicle, when the power system fails, the vehicle often cannot return to the vehicle maintenance point, and can only carry out emergency braking. Even if the fault level does not exceed the threshold value, it may cause the vehicle to deviate from the preset trajectory, and even cause the vehicle to lose stability and have accidents. Therefore, the existing fault processing measures for a four-wheel distributed electric drive autonomous vehicle have certain safety risks.

### SUMMARY

The purpose of the present disclosure is to provide a fault-tolerant tracking control method of a four-wheel distributed electric drive autonomous vehicle, which can ensure the vehicle to drive along a planned path or carry out emergency risk avoiding when the driving system of the vehicle fails and the hub motor cannot provide the required torque, so as to improve the safety of the vehicle.

A fault-tolerant tracking control method of a four-wheel distributed electric drive autonomous vehicle comprises the steps of:

S0: setting initial conditions;

wherein a four-wheel distributed electric drive autonomous vehicle is equipped with hub motors in four wheels to provide power; the actual output torque of each hub motor during normal driving is Tᵢ, i=1, 2, 3, 4, which corresponds to a left front wheel, a right front wheel, a left rear wheel and a right rear wheel, its value is equal to the output torque Tᵣᵢ (i=1, 2, 3, 4) required for vehicle tracking, and the output torque of each hub motor is separately and independently controlled by the corresponding motor controller;

the fault coefficient of each hub motor is set as ξᵢ (i=1, 2, 3, 4), its value is the ratio of the actual output torque Tᵢ of the hub motor to the required output torque Tᵣᵢ, the value range is [0, 1]; when the fault coefficient of each hub motor of the vehicle is 1, it is in the ideal working state; when the fault coefficient of a hub motor is 0, it means that the wheel has completely lost the driving force of the motor; when the fault coefficient of a hub motor is between 0 and 1, it means that the wheel motor can still provide some required driving torque;

the fault identification of the hub motor is set as Sᵢ (i=1, 2, 3, 4), when a hub motor works normally, Sᵢ is 0, if it is in the fault state, Sᵢ is set to 1;

the power system fault cannot be recovered in a short time by restarting the motor or the vehicle is in a state that does not have the conditions for immediate repair;

S1: obtaining the output torque and the fault coefficient of a hub motor, wherein the method is as follows:

obtaining the current driving state of the four-wheel distributed electric drive autonomous vehicle by a relevant on-board controller, transmitting the sensor signal to the VCU through the CAN bus; calculating and providing the reference driving state of the vehicle by the vehicle planning decision-making layer in the on-board industrial computer, and transmitting the reference driving state to the VCU through the CAN bus; according to the deviation between the current driving state and the reference driving state of the vehicle, calculating the required output torque of the hub motor through the existing tracking control strategy by the VCU.

Because of the power system fault caused by the fault of the motor controller, the output torque of the hub motor cannot be directly obtained by its corresponding motor controller. In the technical scheme, the actual output torque of each hub motor is estimated in real time through the parameter real-time observer set in the VCU based on the measured values of the vehicle speed sensor, the yaw angle acceleration sensor and the wheel speed sensor. The fault coefficient of the hub motor is calculated from the real-time estimated value of the actual output torque and the required output torque.

S2: fault diagnosis and fault-tolerant tracking, wherein the flow is as follows:

first, it is judged whether the vehicle power system enters a fault state; if the fault coefficient of a certain hub motor is kept below a higher threshold (the threshold should generally be in the range of [0.7, 0.9]) for a long time or at a lower threshold (the threshold should generally be in the range of [0.3, 0]) for a certain time, it is considered that the hub motor is in the fault state, Sᵢ is set to 1, entering the set fault-tolerant tracking link;

in the fault-tolerant tracking link, first, it is necessary to judge the fault modes of the current vehicle to determine whether the vehicle is in a controllable state at present: according to the number and position of the faulty hub motors, the vehicle fault modes are classified into six types, including: \textcircled{1} fault of a single motor at any position; \textcircled{2} fault of two motors on the same side; \textcircled{3} fault of two motors on different sides and same axes; \textcircled{4} fault of two motors on different sides and different axes; \textcircled{5} fault of three motors at any position; \textcircled{6} fault of all four motors; according to engineering experience, the vehicle is still in controllable state in \textcircled{1} to \textcircled{5} fault modes, and the vehicle is in completely uncontrollable state in \textcircled{6} fault mode;

S3: using different control logics for different fault modes as follows.

(1) When the vehicle is in any one of \textcircled{1} \textcircled{2} \textcircled{3} \textcircled{4} fault modes, the vehicle is in a controllable state, the compensation of the transverse and longitudinal driving force of the vehicle is realized through other hub motors and active steering systems working normally. The compensation method is as follows: introducing the fault coefficient ξi into the original control strategy, which is re-integrated into the fault-tolerant tracking control strategy; during steering, compensating the yaw moment by using the hub motor working normally; if the required yaw moment compensation value is too large and exceeds the working limit of the hub motor, providing additional yaw angle compensation by an active steering system; when driving in a straight line, providing yaw angle compensation only by the active steering system for vehicle yaw caused by the fault of the hub motor. Through the above compensation method, the vehicle realizes fault-tolerant tracking in \textcircled{1} \textcircled{2} \textcircled{3} \textcircled{4} fault modes.

(2) When the vehicle is in \textcircled{5} fault mode, although the vehicle is in a controllable state, the vehicle is capable of only driving at a very low speed and uncapable of tracking effectively in the face of complex paths. At this time, the vehicle VCU reports the fault to the path planning layer through the CAN bus. After receiving the fault report from the CAN bus, the path planning layer abandons the original planned path and re-plans the path according to the current vehicle driving environment with a safe parking spot as the target. The vehicle VCU tracks the re-planned path, drives at a low speed and stops at a safe parking spot at last;

(3) When the vehicle is in \textcircled{6} fault mode, the vehicle is in an uncontrollable state. At this time, the vehicle is uncapable of avoiding danger in an emergency. No matter whether the driving environment where the vehicle is located at present is capable of guaranteeing the safety of the vehicle during emergency braking, braking measures should be taken, that is, the vehicle actively cuts off the energy supply of the hub motor, and the brake-by-wire system adopts emergency braking or controlled deceleration braking scheme according to the driving speed of the vehicle at this time. If the driving speed of the vehicle does not exceed the low-speed limit value at this time or the driving speed exceeds the low-speed limit value but the driving environment meets the emergency braking condition of the vehicle (that is, emergency braking will not result in potential safety hazards), the brake performs emergency braking; if the driving speed of the vehicle exceeds the low speed limit at this time and the driving environment does not meet the emergency braking condition, the vehicle braking deceleration should be guaranteed not to exceed the safe braking deceleration, so as to avoid the rear-end collision problems caused by sudden braking as much as possible.

According to the present disclosure, aiming at different fault conditions of a power system of the distributed electric drive autonomous vehicle, different control methods and compensation modes are utilized to realize vehicle fault-tolerant tracking or emergency risk avoiding on the premise of ensuring vehicle safety as much as possible.

### BRIEF DESCRIPTION OF THE DRAWINGS

FIG. 1 is a structural schematic diagram of a distributed electric drive vehicle according to the present disclosure;

FIG. 2 is a schematic diagram of the signal flow of a distributed electric drive vehicle according to the present disclosure;

FIG. 3 is a general architecture diagram of the technical scheme according to the present disclosure;

FIG. 4 is a schematic diagram of fault diagnosis logic according to the present disclosure;

FIG. 5 is a flow chart of fault-tolerant tracking control according to the present disclosure.

### DETAILED DESCRIPTION OF THE EMBODIMENTS

The specific technical scheme of the present disclosure will be explained in conjunction with embodiments.

S0: Initial conditions are set.

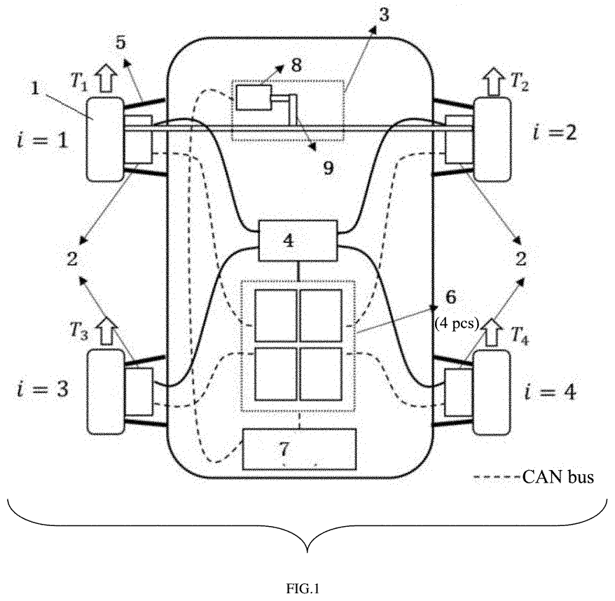

The basic structural schematic diagram of the four-wheel distributed electric drive autonomous vehicle is shown in FIG. 1 by default. The structure of the distributed electrically driven autonomous vehicle according to the present disclosure mainly comprises a wheel 1, a hub motor 2, an active steering system 3, a power battery pack 4, a DC/DC component, a VCU7 (vehicle controller), etc. The active steering system 3 comprises a steering motor 8 and a steering device 9. The four hub motors 2 are inside the four wheels 1, and the hub motor 2 has a direct mechanical connection and support mechanism 5 with the corresponding wheel 1. There is a power battery pack 4 in the vehicle. On one hand, its electric energy is converted into three-phase electricity by the motor controller 6 to power each hub motor 2, and on the other hand, it reduces voltage by the DC/DC component to power low-voltage components such as VCU7 and steering motor 8. Meanwhile, each hub motor 2 and its corresponding controller, each motor controller 6 and VCU7, and each steering motor 8 and VCU7 are connected by CAN bus for bidirectional signal transmission.

The actual output torque of each hub motor 2 during normal driving is Tᵢ (i=1, 2, 3, 4, corresponding to the left front wheel, the right front wheel, the left rear wheel and the right rear wheel, respectively), which is equal to the required output torque Tᵣᵢ (i=1, 2, 3, 4) for vehicle tracking. The output torque of each hub motor 2 is separately and independently controlled by the corresponding motor controller 6. The fault coefficient of each hub motor is set as ξᵢ (i=1, 2, 3, 4), its value is the ratio of the actual output torque Tᵢ of the hub motor 2 to the required output torque Tᵣᵢ, and the value range is [0, 1]. When the fault coefficient of each hub motor of the vehicle is 1, it is in a fault-free state; when the fault coefficient of a hub motor is 0, it means that the wheel has completely lost the driving force of the motor; when the fault coefficient of a hub motor is between 0 and 1, it means that the wheel motor can still provide some required driving torque. The fault identification of the hub motor is set as Sᵢ (i=1, 2, 3, 4). When a hub motor 2 works normally, Sᵢ is 0. If it is in the fault state, Sᵢ is set to 1. By default, the power system fault discussed in this technical scheme cannot be recovered in a short time by restarting the motor or the vehicle is in a state that does not have the conditions for immediate repair.

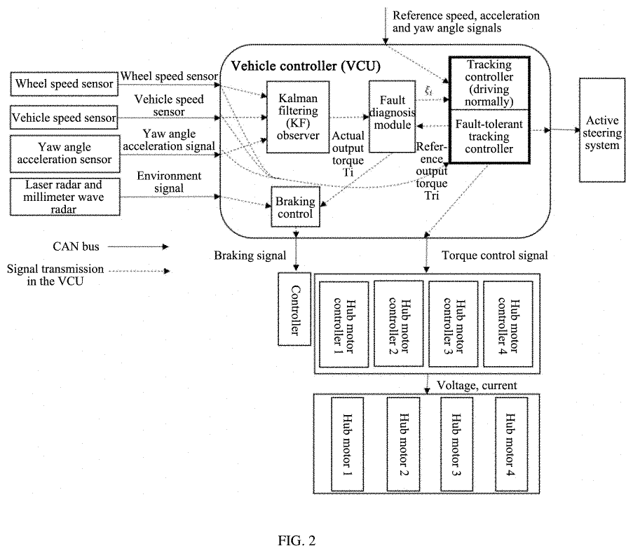

This technical scheme is mainly carried out in the vehicle controller VCU. The schematic diagram of information transmission of VCU and its related components is shown in FIG. 2. In the driving process of the vehicle, the vehicle-mounted sensor provides the VCU with corresponding vehicle state and environmental information. The present disclosure mainly uses the wheel speed information acquired by the wheel speed sensor; the vehicle speed information acquired by the vehicle speed sensor; the yaw angle acceleration information acquired by the yaw angle acceleration; the environmental information acquired by laser radar and millimeter wave radar. The above information is mainly transmitted to the VCU through the CAN bus. At the same time, the VCU will receive the reference trajectory information from the planning decision-making level, including the reference speed, acceleration and yaw angle that the vehicle should reach. In the VCU, the received information of vehicle speed, wheel speed and yaw angle acceleration can observe the actual output torque of each hub motor in real time through the preset parameter real-time observer. In an embodiment of the present disclosure, the preset parameter real-time observer includes but is not limited to a Kalman Filtering (KF) observer, an Extended Kalman Filtering (EKF) observer, an Unscented Kalman Filter observer, a Luenberger Observer (LO), etc. The technical feature is the optimal real-time estimation of the actual output torque Tᵢ of the motor through various observation data of the vehicle. At the same time, the tracking controller performs tracking control according to the deviation between the parameters such as the reference speed and the acceleration and the actual corresponding parameters, and calculates the steering angle of the vehicle steering system and the reference output torque Tᵣᵢ that each hub motor should output. The steering angle information of the vehicle steering system is sent to the vehicle active steering system through the CAN bus to realize the steering control of the vehicle. On the one hand, the control signal of the reference output torque Tᵣᵢ is sent to each hub motor controller through the CAN bus, and the corresponding controller controls the output torque of each hub motor by adjusting the voltage and current output to each hub motor; on the other hand, it is sent to the fault diagnosis module in the VCU. The fault diagnosis module determines whether the fault-tolerant tracking control strategy is adopted in the tracking controller and whether to brake by calculating and judging the fault coefficient and working state of each hub motor. In an embodiment of the present disclosure, the fault-tolerant tracking control methods adopted by vehicles include but are not limited to fuzzy logic PID control, adaptive model predictive control (AMPC), Sliding Mode Control (SMC), etc. The main technical feature is that the original control structure is adjusted in real time according to the fault coefficient obtained in real time, so that it can adapt to the change of fault parameters and reduce the deviation between the actual state and the reference state of the vehicle as much as possible, thus realizing the vehicle tracking control.

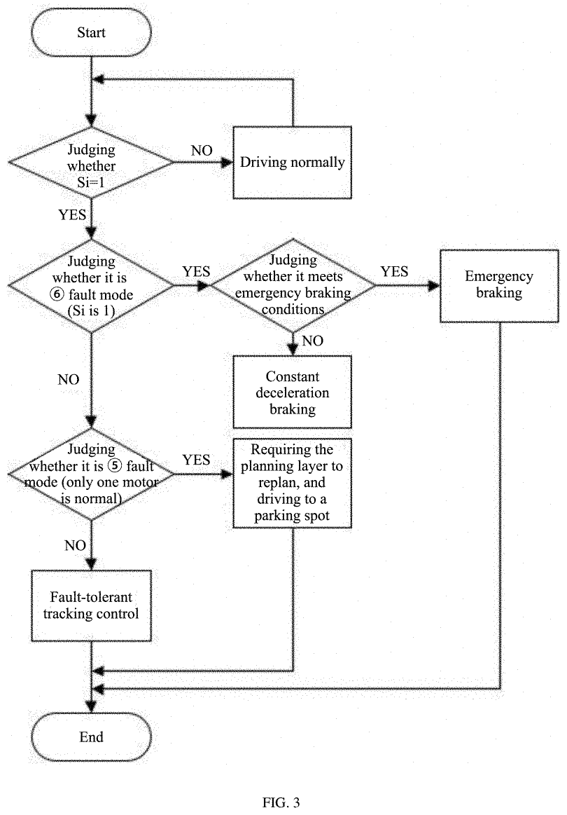

The general architecture of the fault-tolerant tracking method for a four-wheel distributed electric drive autonomous vehicle proposed by the present disclosure is shown in FIG. 3. To specify its working mechanism, it can be assumed that the vehicle drives in the urban environment at a speed of 50 km/h, followed by a vehicle 20 m far away. The vehicle performs vehicle fault-tolerant tracking control according to the following steps.

S1: The output torque and the fault coefficient of a hub motor are obtained. Corresponding parameters can be obtained according to the information transmission flow of VCU and its related components.

S2: Fault diagnosis and fault-tolerant tracking has the following flow.

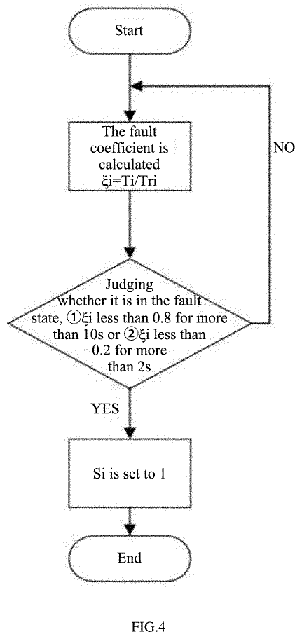

First, it is judged whether the vehicle power system enters a fault state. It is assumed that the criteria for judging the fault state of the vehicle power system are as follows, as shown in FIG. 4. If the fault coefficient of a certain hub motor is kept below 0.8 for more than 10 s or below 0.2 for more than 2 s, it is considered that the hub motor is in the fault state, Sᵢ is set to 1. If a certain hub motor of the vehicle is judged to be in the fault state, it will enter the fault-tolerant tracking link set by the technical scheme.

In the fault-tolerant tracking link, first, it is necessary to judge the fault modes of the current vehicle to determine whether the vehicle is in a controllable state at present. According to the number and position of the faulty hub motors, the vehicle fault modes are classified into six types, including: \textcircled{1} fault of a single motor at any position; \textcircled{2} fault of two motors on the same side; \textcircled{3} fault of two motors on different sides and same axes; \textcircled{4} fault of two motors on different sides and different axes; \textcircled{5} fault of three motors at any position; \textcircled{6} fault of all four motors. According to engineering experience, the vehicle is still in controllable state in \textcircled{1} to \textcircled{5} fault modes, and the vehicle is in completely uncontrollable state in \textcircled{6} fault mode;

S3: Different control logics are used for different fault modes, which is described as follows.

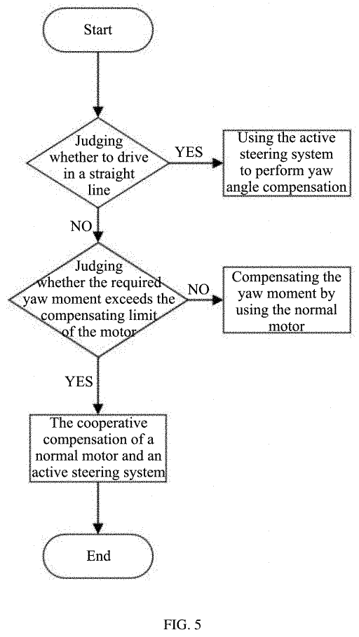

(1) When the vehicle is in any one of \textcircled{1} \textcircled{2} \textcircled{3} \textcircled{4} fault modes, the vehicle is in a controllable state. The compensation of the transverse and longitudinal driving force of the vehicle is realized through other hub motors and active steering systems working normally. The compensation method is shown in FIG. 5. For example, if the vehicle is in \textcircled{1} fault mode, its right front wheel motor completely loses its driving ability, and its reference track has multiple turns. After calculation, the yaw moment required for the vehicle to drive according to the original reference track has exceeded the compensation limit of the other three hub motors. According to the flow shown in FIG. 5, the cooperative compensation mode of a normal motor and an active steering system will be adopted. The main technical features of this cooperative compensation method are that three normal motors are controlled by direct yaw moment control (DYC), so as to have differential speed and differential torque conditions and produce a certain yaw moment. At the same time, the vehicle can drive along the original reference track using the active steering system by increasing, decreasing or fluctuating the wheel turning angle when being combined with the yaw moment generated by DYC, that is, fault-tolerant tracking can be realized.

(2) If the vehicle is in \textcircled{5} fault mode, although the vehicle is in a controllable state, the vehicle is capable of only traveling at a very low speed and uncapable of tracking effectively in the face of complex paths. At this time, the vehicle VCU reports the fault to the path planning layer through the CAN bus. The path planning layer abandons the original planned path and re-plans the path according to the current vehicle driving environment with a safe parking spot as the target. The vehicle VCU tracks the re-planned path, drives at a low speed and stops at a safe parking spot at last.

(3) When the vehicle is in \textcircled{6} fault mode, the vehicle is in an uncontrollable state. At this time, the vehicle cannot drive to a safe parking spot. Therefore, no matter whether the driving environment where the vehicle is located at present is capable of guaranteeing the safety of the vehicle during emergency braking, braking measures should be taken, that is, the vehicle actively cuts off the energy supply of the hub motor, and braking is performed by the brake-by-wire system. According to the actual situation of urban transportation, assuming that the emergency braking condition of the vehicle at this time is that the driving speed of the vehicle is lower than 36 km/h or there is no vehicle following within 30 m behind the vehicle, it can be seen that the vehicle in the example mentioned in this embodiment does not meet the emergency braking condition, so that it is necessary to brake at a constant braking deceleration according to the speed and distance of the following vehicle, so as to provide reaction time for the rear vehicle as much as possible and avoid rear-end collision problem caused by sudden braking. Assuming that the safe braking deceleration is 4 m/s² after obtaining the speed of the following vehicle through a sensing device such as laser radar, the vehicle should decelerate at a braking deceleration not greater than the safe deceleration, and finally realize safe braking and parking.

It should be noted that the above is only a specific example of the present disclosure. The present disclosure is not limited to the above embodiments. All local modifications, equivalent substitutions, improvements, etc. made on the basis of the spirit and principles of the present disclosure should be included in the scope of protection of the present disclosure.

What is claimed is:

1. A fault-tolerant tracking control method of a four-wheel distributed electric drive autonomous vehicle, comprising the steps of:
S0: setting initial conditions;
wherein a four-wheel distributed electric drive autonomous vehicle is equipped with hub motors in four wheels to provide power; the actual output torque of each hub motor during normal driving is Tᵢ, i=1, 2, 3, 4, which corresponds to a left front wheel, a right front wheel, a left rear wheel and a right rear wheel, its value is equal to the output torque Tᵣᵢ required for vehicle tracking, i=1, 2, 3, 4, and the output torque of each hub motor is separately and independently controlled by the corresponding motor controller;
the fault coefficient of each hub motor is set as ξᵢ, i=1, 2, 3, 4, its value is the ratio of the actual output torque Tᵢ of the hub motor to the required output torque Tᵣᵢ, the value range is [0, 1]; when the fault coefficient of each hub motor of the vehicle is 1, it is in the ideal working state; when the fault coefficient of a hub motor is 0, it means that the wheel has completely lost the driving force of the motor; when the fault coefficient of a hub motor is between 0 and 1, it means that the wheel motor can still provide some required driving torque;
the fault identification of the hub motor is set as Sᵢ, i=1, 2, 3, 4, when a hub motor works normally, Sᵢ is 0, if it is in the fault state, Sᵢ is set to 1; and
the power system fault cannot be recovered in a short time by restarting the motor or the vehicle is in a state that does not have the conditions for immediate repair;
S1: obtaining the output torque and the fault coefficient of a hub motor;
S2: fault diagnosis and fault-tolerant tracking, wherein the flow is as follows:
first, it is judged whether the vehicle power system enters a fault state; if the fault coefficient of a certain hub motor is kept below 0.8 for more than 10 s or below 0.2 for more than 2 s, it is considered that the hub motor is in the fault state, Sᵢ is set to 1, entering the fault-tolerant tracking link;
in the fault-tolerant tracking link, first, it is necessary to judge the fault modes of the current vehicle to determine whether the vehicle is in a controllable state at present: according to the number and position of the faulty hub motors, the vehicle fault modes are classified into six types, including: \textcircled{1} fault of a single motor at any position; \textcircled{2} fault of two motors on the same side; \textcircled{3} fault of two motors on different sides and same axes; \textcircled{4} fault of two motors on different sides and different axes; \textcircled{5} fault of three motors at any position; \textcircled{6} fault of all four motors; according to engineering experience, the vehicle is still in controllable state in \textcircled{1} to \textcircled{5} fault modes, and the vehicle is in completely uncontrollable state in \textcircled{6} fault mode; and
S3: using different control logics for different fault modes:
(1) when the vehicle is in any one of \textcircled{1} \textcircled{2} \textcircled{3} \textcircled{4} fault modes, the vehicle is in a controllable state, the compensation of the transverse and longitudinal driving force of the vehicle is realized through other hub motors and active steering systems working normally, and the vehicle realizes fault-tolerant tracking in \textcircled{1} \textcircled{2} \textcircled{3} \textcircled{4} fault modes through compensation;
(2) when the vehicle is in \textcircled{5} fault mode, although the vehicle is in a controllable state, the vehicle is capable of only driving at a very low speed and uncapable of tracking effectively in the face of complex paths; at this time, the vehicle VCU reports the fault to the path planning layer through the CAN bus; after receiving the fault report from the CAN bus, the path planning layer abandons the original planned path and re-plans the path according to the current vehicle driving environment with a safe parking spot as the target; the vehicle VCU tracks the re-planned path, drives at a low speed and stops at a safe parking spot at last; and
(3) when the vehicle is in \textcircled{6} fault mode, the vehicle is in an uncontrollable state; at this time, the vehicle is uncapable of avoiding danger in an emergency; no matter whether the driving environment where the vehicle is located at present is capable of guaranteeing the safety of the vehicle during emergency braking, braking measures should be taken, that is, the vehicle actively cuts off the energy supply of the hub motor, and the brake-by-wire system adopts emergency braking or controlled deceleration braking scheme according to the driving speed of the vehicle at this time.

2. The fault-tolerant tracking control method of a four-wheel distributed electric drive autonomous vehicle according to claim 1, wherein S1: obtaining the output torque and the fault coefficient of a hub motor comprises:
obtaining the current driving state of the four-wheel distributed electric drive autonomous vehicle by a relevant on-board controller, transmitting the sensor signal to the VCU through the CAN bus; calculating and providing the reference driving state of the vehicle by the vehicle planning decision-making layer in the on-board industrial computer, and transmitting the reference driving state to the VCU through the CAN bus; according to the deviation between the current driving state and the reference driving state of the vehicle, calculating the required output torque of the hub motor through the existing tracking control strategy by the VCU;
estimating the actual output torque of each hub motor in real time through the Kalman filter observer set in the VCU based on the measured values of the vehicle speed sensor, the yaw angle acceleration sensor and the wheel speed sensor; and
calculating the fault coefficient of the hub motor from the real-time estimated value of the actual output torque and the required output torque.

3. The fault-tolerant tracking control method of a four-wheel distributed electric drive autonomous vehicle according to claim 1, wherein the compensation method in step (1) of S3 is as follows:
introducing the fault coefficient ξi into the original control strategy, which is re-integrated into the fault-tolerant tracking control strategy;
during steering, compensating the yaw moment by using the hub motor working normally through the direct yaw moment control method;
if the required yaw moment compensation value is too large and exceeds the working limit of the hub motor, providing additional yaw angle compensation by an active steering system; and
when driving in a straight line, providing yaw angle compensation only by the active steering system for vehicle yaw caused by the fault of the hub motor.

4. The fault-tolerant tracking control method of a four-wheel distributed electric drive autonomous vehicle according to claim 1, wherein in step (3) of S3, if the driving speed of the vehicle does not exceed the low-speed limit value or the driving speed exceeds the low-speed limit value but the driving environment meets the emergency braking condition of the vehicle, the brake performs emergency braking; if the driving speed of the vehicle exceeds the low speed limit and the driving environment does not meet the emergency braking condition, the vehicle braking deceleration should be guaranteed not to exceed the safe braking deceleration, so as to avoid the problems caused by sudden braking as much as possible.
